(19) United States
(12) Patent Application Publication
(10) Pub. No.: US 2015/0042871 A1
(43) Pub. Date: Feb. 12, 2015

(54) CONTROL METHOD, CONTROL APPARATUS AND ELECTRONIC DEVICE

(71) Applicants: Lenovo (Beijing) Co., Ltd., Beijing (CN); Beijing Lenovo Software Ltd., Beijing (CN)

(72) Inventor: Qizhong Zheng, Beijing (CN)

(73) Assignees: Lenovo (Beijing) Co., Ltd., Beijing (CN); Beijing Lenovo Software Ltd., Beijing (CN)

(21) Appl. No.: 14/229,926

(22) Filed: Mar. 30, 2014

(30) Foreign Application Priority Data
Aug. 9, 2013 (CN) 201310347314.4

(51) Int. Cl. H04N 5/235

(52) U.S. Cl. CPC H04N 5/2354
USPC 348/370

(57) ABSTRACT

A control method, a control apparatus and an electronic device are provided. The control method is applicable to an electronic device including an image acquisition unit and a light source, an acquisition region of the image acquisition unit at least partially overlaps with an illumination region of the light source. The method includes: obtaining a distance between the image acquisition unit and an acquired object in the acquisition region; obtaining a set of correspondence relationships of distances between the image acquisition unit and acquired objects with respect to light source parameters, where the set includes at least two different correspondence relationships; selecting a light source parameter according to the distance and the correspondence relationship; and controlling the light source according to the light source parameter in the course of acquiring the acquired object by the image acquisition unit.

This application claims the priority to Chinese Patent Application No. 201310347314.4, entitled “CONTROL METHOD, CONTROL APPARATUS AND ELECTRONIC DEVICE”, filed with the Chinese Patent Office on Aug. 9, 2013, which is incorporated by reference in its entirety herein.

### FIELD OF THE TECHNOLOGY

The present application relates to the field of light source control, and in particular to an exposure compensation control method, an exposure compensation control method apparatus and an electronic device.

### BACKGROUND

Typically automatic flash control may be performed when a picture is took using an electronic device, e.g., a camera, built in a mobile terminal (e.g., a mobile phone, a tablet computer, etc). At present, the following several schemes are common in automatic flash control: the electronic device judges from the brightness of the picture to be took whether there are sufficient light, and activates a light source (e.g., a flash lamp) for an exposure compensation in the case of the insufficient light, i.e., weak light; or performs an exposure compensation with different brightness on different zooming segments.

However, in the existing exposure compensation schemes, a value of the exposure compensation cannot be adjusted accordingly in response to the distance between the electronic device and an acquired object in an acquisition region, and an appropriate exposure compensation cannot be selected in view of a brightness of an object to be took (e.g., a human face).

### SUMMARY

In view of this, a control method, a control apparatus and an electronic device are provided, to adjust a value of the exposure compensation in response to the distance between the electronic device and an acquired object in an acquisition region.

In order to attain the foregoing object, technical solutions of the embodiments of the application are achieved as follows.

An embodiment of the application provides a control method, applied to an electronic device including an image acquisition unit and a light source, wherein an acquisition region of the image acquisition unit at least partially overlaps with an illumination region of the light source, and the method includes:

obtaining a distance between the image acquisition unit and an acquired object in the acquisition region;

obtaining a set of correspondence relationships of distances between the image acquisition unit and acquired objects with respect to light source parameters, wherein the set includes at least two different correspondence relationships;

selecting a light source parameter according to the obtained distance and the correspondence relationship; and

controlling the light source according to the light source parameter in the course of acquiring the acquired object by the image acquisition unit.

Preferably the obtaining a distance between the image acquisition unit and an acquired object in the acquisition region includes:

detecting a motion distance of a driving unit of the electronic device and calculating the distance between the image acquisition unit and the acquired object from the motion distance.

Preferably the calculating the distance between the image acquisition unit and the acquired object from the motion distance includes:

obtaining an image distance from a duty ratio of a Pulse Width Modulation signal received by the driving unit; and

calculating an object distance according to a relationship among object distances, focus distances and image distances, wherein the object distance is the distance between the image acquisition unit and the acquired object.

Preferably the method further includes:

determining a distance range into which the obtained distance falls; and selecting a correspondence relationship from the set of correspondence relationships according to a mapping table of distance ranges to correspondence relationships.

Preferably the method further includes:

obtaining a brightness value of a preset acquired object; and

judging an activation of the light source, in the case that a ratio of the brightness value of the preset acquired object to a maximum brightness value is smaller than a preset value.

Preferably the preset acquired object is a human face; and

correspondingly the obtaining a brightness value of a preset acquired object includes:

recognizing the human face; and

making a statistic of pixels in a central part of the human face to obtain the brightness value.

An embodiment of the application provides a control apparatus, applied to an electronic device including an image acquisition unit and a light source, wherein an acquisition region of the image acquisition unit at least partially overlaps with an illumination region of the light source, and the apparatus includes:

a distance obtaining unit configured to obtain a distance between the image acquisition unit and an acquired object in the acquisition region;

a correspondence relationship set obtaining unit configured to obtain a set of correspondence relationships of distances between the image acquisition unit and acquired objects with respect to light source parameters, wherein the set includes at least two different correspondence relationships.

a light source parameter selection unit configured to select a light source parameter according to the obtained distance and the correspondence relationship.

a light source control unit configured to control the light source according to the light source parameter in the course of acquiring the acquired object by the image acquisition unit.

Preferably the distance obtaining unit is further configured to detect a motion distance of a driving unit of the electronic device and to calculate the distance between the image acquisition unit and the acquired object from the motion distance.

Preferably the distance obtaining unit is further configured to obtain an image distance from a duty ratio of a Pulse Width Modulation signal received by the driving unit; and

calculate an object distance according to a relationship among object distances, focus distances and image distances, wherein the object distance is the distance between the image acquisition unit and the acquired object.

Preferably the apparatus further includes a correspondence relationship selection unit configured to determine a distance range into which the obtained distance falls, and to select a correspondence relationship from the set of correspondence relationships according to a mapping table of distance ranges to correspondence relationships.

Preferably the apparatus further includes a brightness value obtaining unit and a judgment unit;

the brightness value obtaining unit is configured to obtain a brightness value of a preset acquired object; and

the judgment unit is configured to judge an activation of the light source, in the case that the ratio of the brightness value of the preset acquired object to a maximum brightness value is smaller than a preset value.

Preferably the preset acquired object is a human face; and

correspondingly the brightness value obtaining unit is configured to recognize the human face, and to make a statistic of pixels in a central part of the human face to obtain the brightness value.

An embodiment of the application provides an electronic device including any of the control apparatuses described above.

As can be apparent, the embodiment of the application provides a control method, applied to an electronic device including an image acquisition unit and a light source. An acquisition region of the image acquisition unit at least partially overlaps with an illumination region of the light source. The method includes: obtaining a distance between the image acquisition unit and an acquired object in the acquisition region; obtaining a set of correspondence relationships of distances between the image acquisition unit and the acquired objects with respect to light source parameters, where the set includes at least two different correspondence relationships; selecting a light source parameter according to the obtained distance and the correspondence relationship; and controlling the light source according to the light source parameter in the course of acquiring the acquired object by the image acquisition unit. Thus the corresponding light source parameter can be selected in response to the distance between the image acquisition unit and the acquired object in the acquisition region to control the light source according to the light source parameter in the course of acquiring the acquired object by the image acquisition unit, thus implementing the purpose of adjusting a value of exposure compensation.

### BRIEF DESCRIPTION OF THE DRAWINGS

FIG. 1 is a flow chart of an implementation of a first embodiment of a control method according to the application;

FIG. 2 is a flow chart of an implementation of a second embodiment of a control method according to the application;

FIG. 3 is a flow chart of an implementation of a third embodiment of a control method according to the application;

FIG. 4 is a flow chart of an implementation of a fourth embodiment of a control method according to the application;

FIG. 5 is a flow chart of an implementation of a fifth embodiment of a control method according to the application;

FIG. 6 is a flow chart of an implementation of a sixth embodiment of a control method according to the application;

FIG. 7 is a flow chart of an implementation of a seventh embodiment of a control method according to the application;

FIG. 8 is a schematic principle diagram of deriving an image distance from a PWM signal received by a driving unit according to the application;

FIG. 9 is a schematic structural diagram of a first embodiment of a control apparatus according to the application; and

FIG. 10 is a schematic structural diagram of a second embodiment of a control apparatus according to the application.

### DETAILED DESCRIPTION OF THE EMBODIMENTS

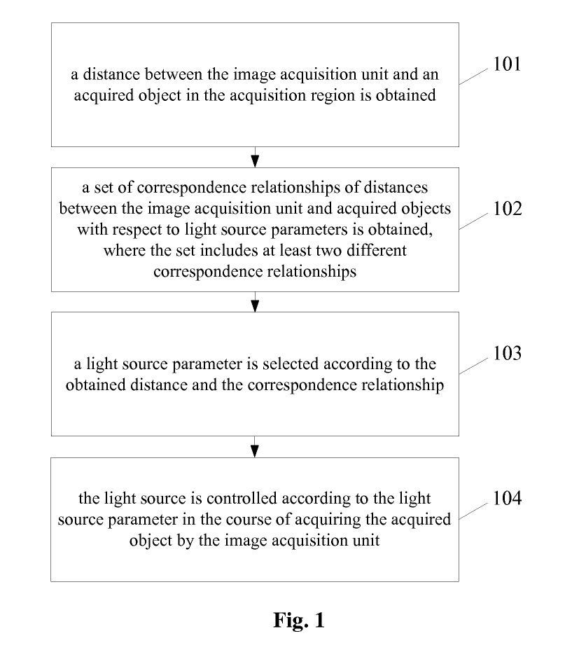

A first embodiment of a control method according to the application is applicable to an electronic device including an image acquisition unit and a light source. An acquisition region of the image acquisition unit at least partially overlaps with an illumination region of the light source. As illustrated in FIG. 1, the method includes steps 101-104.

In step 101, a distance between the image acquisition unit and an acquired object in the acquisition region is obtained.

In step 102, a set of correspondence relationships of distances between the image acquisition unit and acquired objects with respect to light source parameters is obtained. The set includes at least two different correspondence relationships.

In step 103, a light source parameter is selected according to the obtained distance and the correspondence relationship.

In step 104, the light source is controlled according to the light source parameter in the course of acquiring the acquired object by the image acquisition unit.

Thus, with the method according to this embodiment, the value of exposure compensation can be adjusted in response to the distance between the electronic device and the acquired object in the acquisition region. In this way, the acquired object is given a larger value of exposure compensation when the electronic device is at a longer distance and the acquired object is given a smaller value of exposure compensation when the electronic device is at a shorter distance to thereby obtain a better effect of taking a picture.

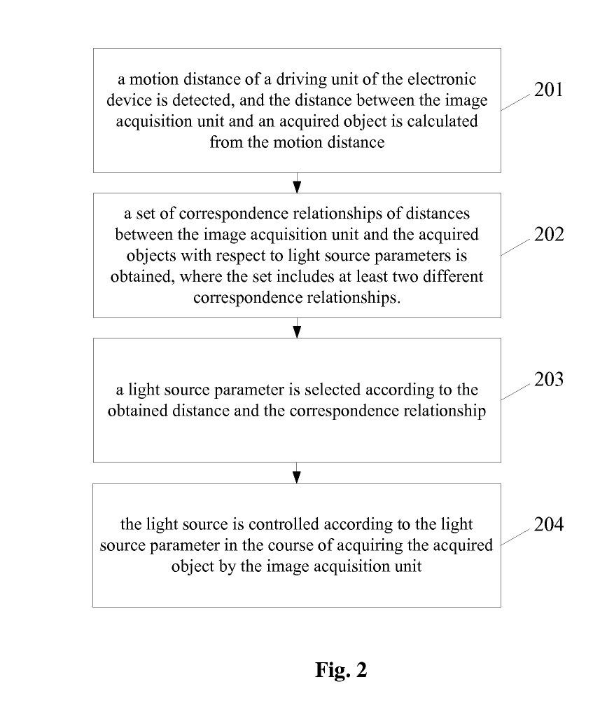

A second embodiment of a control method according to the application is applicable to an electronic device including an image acquisition unit and a light source. An acquisition region of the image acquisition unit at least partially overlaps with an illumination region of the light source. As illustrated in FIG. 2, the method includes steps 201-204.

In step 201, a motion distance of a driving unit of the electronic device is detected, and the distance between the image acquisition unit and an acquired object is calculated from the motion distance.

Herein, the driving unit may be a Voice Coil Motor (VCM).

In step 202, a set of correspondence relationships of distances between the image acquisition unit and the acquired objects with respect to light source parameters is obtained. The set includes at least two different correspondence relationships.

In step 203, a light source parameter is selected according to the obtained distance and the correspondence relationship.

In step 204, the light source is controlled according to the light source parameter in the course of acquiring the acquired object by the image acquisition unit.

Thus, with the method according to this embodiment, the accurate distance between the image acquisition unit and the acquired object can be obtained from the motion distance of the driving unit of the electronic device, and the value of exposure compensation can be further adjusted precisely according to the accurate distance, thus obtaining a better effect of taking a picture.

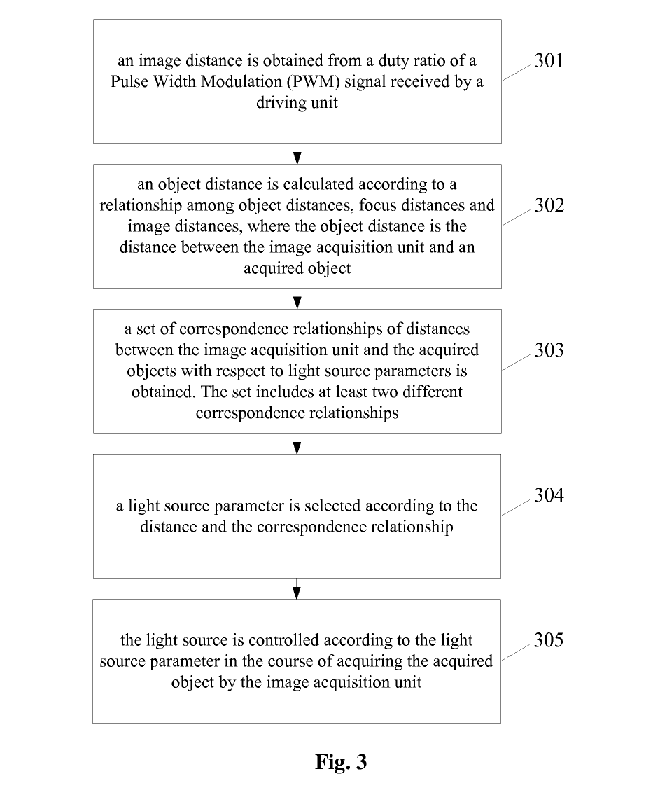

A third embodiment of a control method according to the application is applicable to an electronic device including an image acquisition unit and a light source. An acquisition region of the image acquisition unit at least partially overlaps with an illumination region of the light source. As illustrated in FIG. 3, the method includes steps 301-305.

In step 301, an image distance is obtained from a duty ratio of a Pulse Width Modulation (PWM) signal received by a driving unit.

Herein, the driving unit may be a VCM.

In step 302, an object distance is calculated according to a relationship among object distances, focus distances and image distances. The object distance is the distance between the image acquisition unit and an acquired object.

In step 303, a set of correspondence relationships of distances between the image acquisition unit and the acquired objects with respect to light source parameters is obtained. The set includes at least two different correspondence relationships.

In step 304, a light source parameter is selected according to the distance and the correspondence relationship.

In step 305, the light source is controlled according to the light source parameter in the course of acquiring the acquired object by the image acquisition unit.

Thus, with the method according to this embodiment, the distance between the image acquisition unit and the acquired object can be obtained simply and rapidly according to the duty ratio of the Pulse Width Modulation (PWM) signal received by the driving unit and the relationship among object distances, focus distances and image distances; and the value of exposure compensation can be further adjusted in a timely manner according to the distance, thus obtaining a better effect of taking a picture.

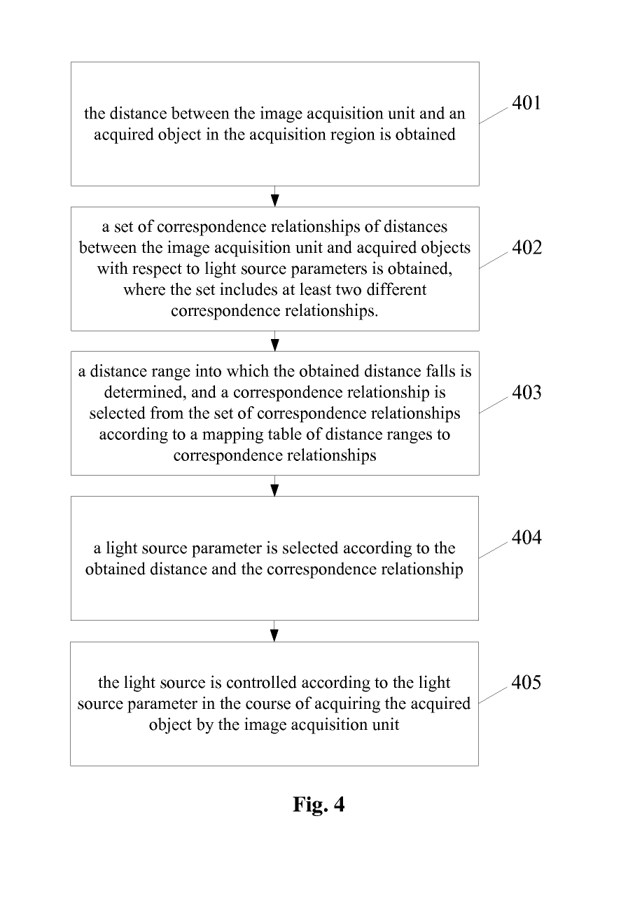

A fourth embodiment of a control method according to the application is applicable to an electronic device including an image acquisition unit and a light source. An acquisition region of the image acquisition unit at least partially overlaps with an illumination region of the light source. As illustrated in FIG. 4, the method includes steps 401-405.

In step 401, the distance between the image acquisition unit and an acquired object in the acquisition region is obtained.

In step 402, a set of correspondence relationships of distances between the image acquisition unit and acquired objects with respect to light source parameters is obtained. The set includes at least two different correspondence relationships.

In step 403, a distance range into which the obtained distance falls is determined, and a correspondence relationship is selected from the set of correspondence relationships according to a mapping table of distance ranges to correspondence relationships.

In step 404, a light source parameter is selected according to the obtained distance and the correspondence relationship.

In step 405, the light source is controlled according to the light source parameter in the course of acquiring the acquired object by the image acquisition unit.

Thus, with the method according to this embodiment, the correspondence relationship can be selected according to the mapping table of distance ranges into which the obtained distance falls to correspondence relationships. Therefore, the light source parameter can be selected simply and rapidly and the value of exposure compensation can be further adjusted in a timely manner according to the distance, thus obtaining a better effect of taking a picture.

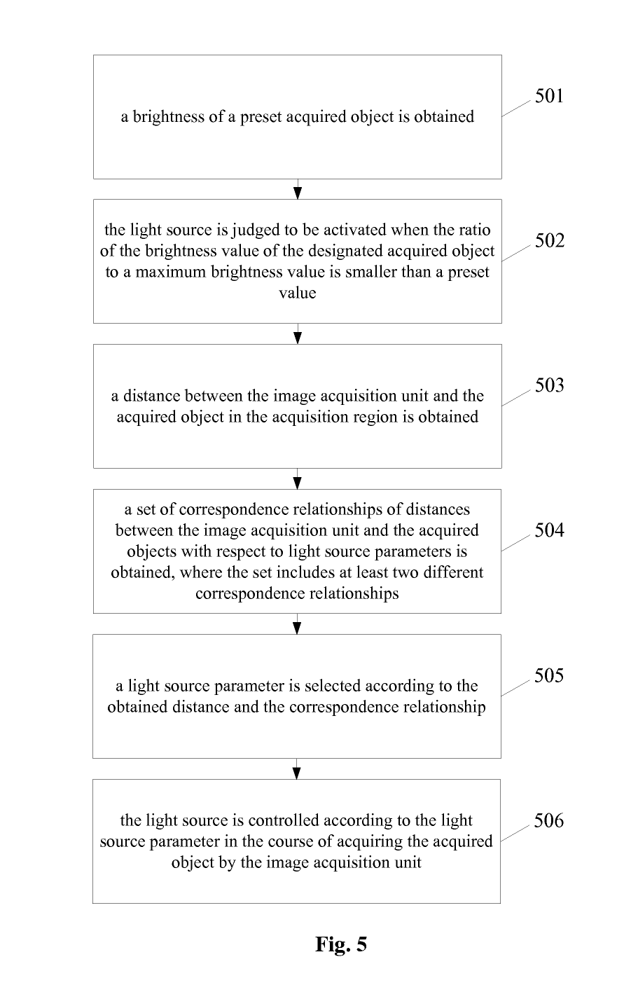

A fifth embodiment of a control method according to the application is applicable to an electronic device including an image acquisition unit and a light source. An acquisition region of the image acquisition unit at least partially overlaps with an illumination region of the light source. As illustrated in FIG. 5, the method includes steps 501-506.

In step 501, a brightness of a preset acquired object is obtained.

In step 502, the light source is judged to be activated when the ratio of the brightness value of the designated acquired object to a maximum brightness value is smaller than a preset value.

In step 503, a distance between the image acquisition unit and the acquired object in the acquisition region is obtained.

In step 504, a set of correspondence relationships of distances between the image acquisition unit and the acquired objects with respect to light source parameters is obtained. The set includes at least two different correspondence relationships.

In step 505, a light source parameter is selected according to the obtained distance and the correspondence relationship.

In step 506, the light source is controlled according to the light source parameter in the course of acquiring the acquired object by the image acquisition unit.

Thus, with the method according to this embodiment, the light source can be judged to be activated when the ratio of the brightness value of the preset acquired object to the maximum brightness value is smaller than the preset value, instead of judging only from the brightness value of a taken picture whether to activate the light source for exposure compensation. The light source for the value of exposure compensation can be activated as needed in practice to thereby obtain a better effect of taking the picture.

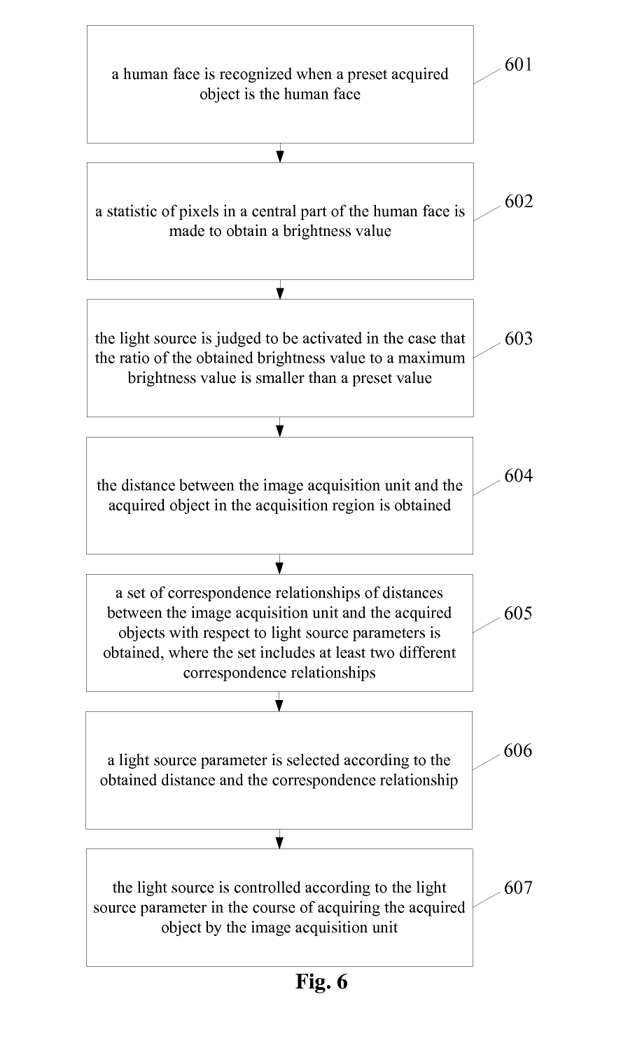

A sixth embodiment of a control method according to the application is applicable to an electronic device including an image acquisition unit and a light source. An acquisition region of the image acquisition unit at least partially overlaps with an illumination region of the light source. As illustrated in FIG. 6, the method includes steps 601-607.

In step 601, a human face is recognized when a preset acquired object is the human face.

In step 602, a statistic of pixels in a central part of the human face is made to obtain a brightness value.

In step 603, the light source is judged to be activated in the case that the ratio of the obtained brightness value to a maximum brightness value is smaller than a preset value.

In step 604, the distance between the image acquisition unit and the acquired object in the acquisition region is obtained.

In step 605, a set of correspondence relationships of distances between the image acquisition unit and the acquired objects with respect to light source parameters is obtained. The set includes at least two different correspondence relationships.

In step 606, a light source parameter is selected according to the obtained distance and the correspondence relationship.

In step 607, the light source is controlled according to the light source parameter in the course of acquiring the acquired object by the image acquisition unit.

Thus, with the method according this embodiment, whether to activate the light source can be judged according to the relationship between the ratio of the brightness value at the central part of the human face to the maximum brightness value and the preset value. Therefore, whether to activate the light source for exposure compensation can be judged more accurately, thus obtaining a better effect of taking the picture.

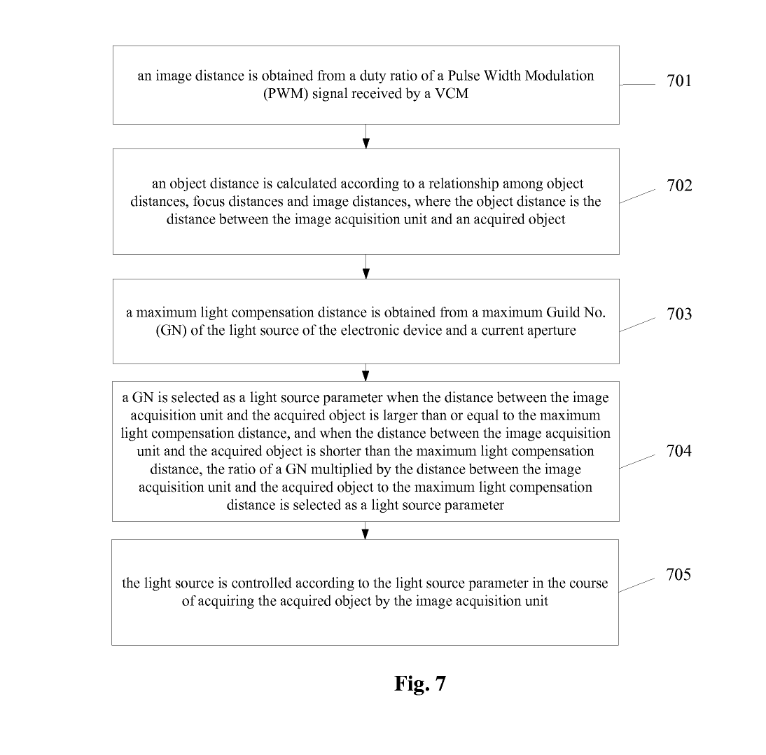

A seventh embodiment of a control method according to the application is applicable to an electronic device including an image acquisition unit and a light source. An acquisition region of the image acquisition unit at least partially overlaps with an illumination region of the light source. As illustrated in FIG. 7, the method includes steps 701-705.

In step 701, an image distance is obtained from a duty ratio of a Pulse Width Modulation (PWM) signal received by a VCM.

In step 702, an object distance is calculated according to a relationship among object distances, focus distances and image distances. The object distance is the distance between the image acquisition unit and an acquired object.

In step 703, a maximum light compensation distance is obtained from a maximum Guild No. (GN) of the light source of the electronic device and a current aperture.

In step 704, a GN is selected as a light source parameter when the distance between the image acquisition unit and the acquired object is larger than or equal to the maximum light compensation distance.

When the distance between the image acquisition unit and the acquired object is shorter than the maximum light compensation distance, the ratio of a GN multiplied by the distance between the image acquisition unit and the acquired object to the maximum light compensation distance is selected as a light source parameter.

In step 705, the light source is controlled according to the light source parameter in the course of acquiring the acquired object by the image acquisition unit.

Thus, with the method according to this embodiment, the value of exposure compensation can be adjusted in response to the distance between the electronic device and the acquired object in the acquisition region. In this way, the acquired object is given a higher amount of exposure compensation when the electronic device is at a longer distance; and the acquired object is given a lower amount of exposure compensation when the electronic device is at a shorter distance, thus obtaining a better effect of taking a picture.

An eighth embodiment of a control method according to the application will be introduced below. The control method according to this embodiment is applicable to an electronic device including an image acquisition unit and a light source. An acquisition region of the image acquisition unit at least partially overlaps with an illumination region of the light source. The method includes steps I-V.

In step I, an image distance is obtained from a duty ratio of a PWM signal received by a driving unit.

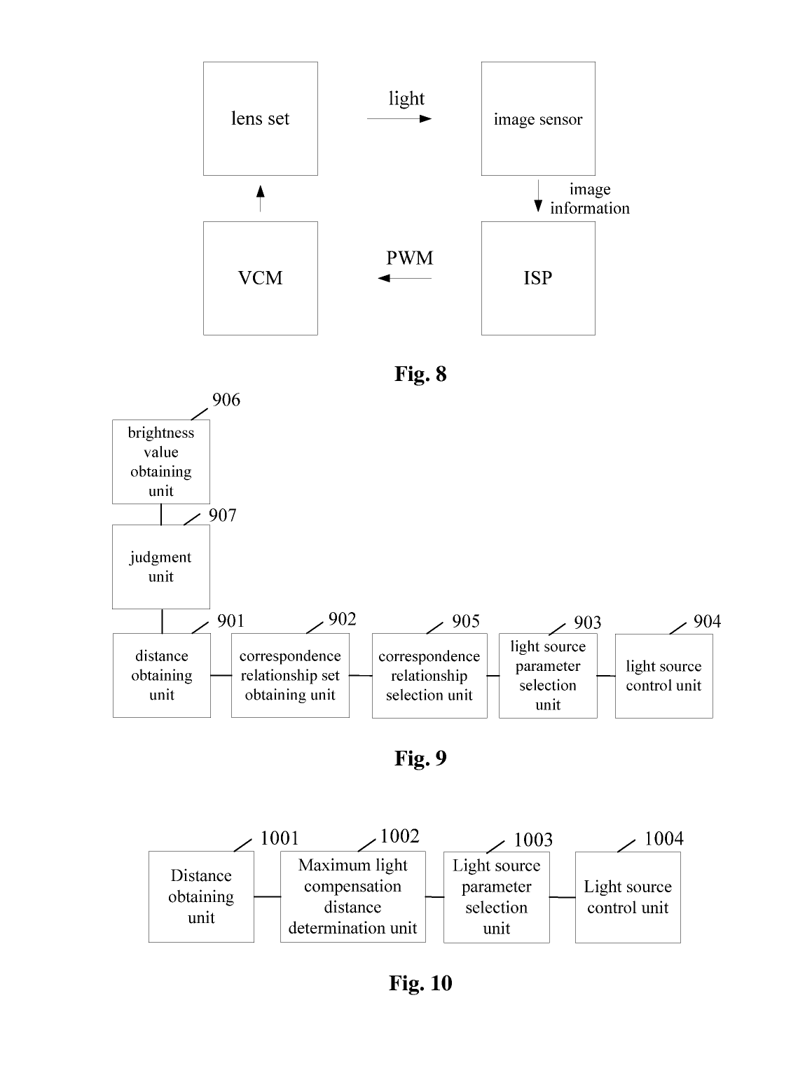

Herein, the driving unit can be a VCM. A principle of obtaining an image distance from a duty ratio of a PWM signal received by the driving unit will be introduced below with reference to FIG. 8.

A set of lenses provides an image sensor with a light source, the image sensor provides an Image Signal Processor (ISP) with image information, and the ISP judges from contrast information in a focusing region whether there is successful on-focusing. If there is no successful on-focusing, the VCM is drove according to the PWM signal to move the set of lenses to a corresponding location until there is successful on-focusing. The current focusing location of the lenses (typically the location where the subject resides) can be calculated by the PWM signal for controlling the VCM via the ISP, information about the current focusing location can be recorded, and the image distance can be obtained from the information about the current focusing location.

In step II, an object distance is obtained according to a relationship among object distances, focus distances and image distances. The object distance is the distance between the image acquisition unit and an acquired object.

In step III, a set of correspondence relationships of distances between the image acquisition unit and the acquired objects with respect to light source parameters is obtained. The set includes at least two different correspondence relationships.

In step IV, a light source parameter is selected according to the distance and the correspondence relationship.

In step V, the light source is controlled according to the light source parameter in the course of acquiring the acquired object by the image acquisition unit.

If there are multiple light sources, the number of activated light sources in the set of light sources, and the power of the light sources are controlled.

Thus, according to the embodiment, when there are multiple light sources the number of activated light sources in the set of light sources and power of the light sources are controlled to thereby enable a strong flash or a weak flash as needed; and the value of exposure compensation can be further better adjusted to thereby obtain a better effect of taking a picture.

A first embodiment of a control apparatus according to the application is applicable to an electronic device including an image acquisition unit and a light source. An acquisition region of the image acquisition unit at least partially overlaps with an illumination region of the light source. As illustrated in FIG. 9, the apparatus includes: a distance obtaining unit 901, a correspondence relationships set obtaining unit 902, a light source parameter selection unit 903, and a light source control unit 904.

The distance obtaining unit 901 is configured to obtain a distance between the image acquisition unit and an acquired object in the acquisition region.

The correspondence relationships set obtaining unit 902 is configured to obtain a set of correspondence relationships of distances between the image acquisition unit and the acquired objects with respect to light source parameters. The set includes at least two different correspondence relationships.

The light source parameter selection unit 903 is configured to select a light source parameter according to the obtained distance and the correspondence relationship.

The light source control unit 904 is configured to control the light source according to the light source parameter in the course of acquiring the acquired object by the image acquisition unit.

Preferably the distance obtaining unit 901 is further configured to detect a motion distance of a driving unit of the electronic device and to calculate the distance between the image acquisition unit and the acquired object from the motion distance;

Herein, the driving unit may be a VCM.

Preferably the distance obtaining unit 901 is further configured to obtain an image distance from a duty ratio of a Pulse Width Modulation (PWM) signal received by the driving unit, and to calculate an object distance according to a relationship among object distances, focus distances and image distances. The object distance is the distance between the image acquisition unit and the acquired object.

Preferably the apparatus further includes a correspondence relationship selection unit 905 configured to determine a distance range into which the obtained distance falls and to select a correspondence relationship from the set of correspondence relationships according to a mapping table of distance ranges to correspondence relationships.

Preferably the apparatus further includes a brightness value obtaining unit 906 and a judgment unit 907.

The brightness value obtaining unit 906 is configured to obtain a brightness value of the preset acquired object.

The judgment unit 907 is configured to judge an activation of the light source, in the case that the ratio of the brightness value of the preset acquired object to a maximum brightness value is smaller than a preset value.

Preferably the preset acquired object is a human face.

Correspondingly the brightness value obtaining unit 906 is configured to recognize a human face and to make a statistic of pixels in a central part of the human face to obtain the brightness value.

Thus, with the control apparatus according to this embodiment, the value of exposure compensation can be adjusted in response to the distance between the electronic device and the acquired object in the acquisition region. In this way, the acquired object is given a higher amount of exposure compensation when the electronic device is at a longer distance and the acquired object is given a lower amount of exposure compensation when the electronic device is at a shorter distance, thus obtaining a better effect of taking a picture.

A second embodiment of a control apparatus according to the application is applicable to an electronic device including an image acquisition unit and a light source. An acquisition region of the image acquisition unit at least partially overlaps with an illumination region of the light source. As illustrated in FIG. 10, the apparatus includes: a distance obtaining unit 1001, a maximum light compensation distance determination unit 1002, a light source parameter selection unit 1003 and a light source control unit 1004.

The distance obtaining unit 1001 is configured to obtain an image distance from a duty ratio of a Pulse Width Modulation (PWM) signal received by a VCM; and to calculate an object distance according to a relationship among object distances, focus distances and image distances. The object distance is the distance between the image acquisition unit and an acquired object.

The maximum light compensation distance determination unit 1002 is configured to obtain a maximum light compensation distance from a maximum Guild No. (GN) of the light source of the electronic device and a current aperture.

The light source parameter selection unit 1003 is configured to select a GN as a light source parameter when the distance between the image acquisition unit and the acquired object is larger than or equal to the maximum light compensation distance, and

to select the ratio of a GN multiplied by the distance between the image acquisition unit and the acquired object to the maximum light compensation distance as a light source parameter when the distance between the image acquisition unit and the acquired object is smaller than the maximum light compensation distance; and

The light source control unit 1004 is configured to control the light source according to the light source parameter in the course of acquiring the acquired object by the image acquisition unit.

Thus, with the control apparatus according to this embodiment, the value of exposure compensation can be adjusted in response to the distance between the electronic device and the acquired object in the acquisition region. In this way, the acquired object is given a higher amount of exposure compensation when the electronic device is at a longer distance and the acquired object is given a lower amount of exposure compensation when the electronic device is at a shorter distance, thus obtaining a better effect of taking a picture.

The application provides an electronic device including any of the control apparatuses described above.

In the several embodiments according to this application, it shall be appreciated that the disclosed devices and methods can be embodied otherwise. The foregoing embodiments of the devices are merely schematic, for example, the division of the devices into the units is merely a logical functional division, and another division is also possible in a practical implementation, for example, a plurality of units or components can be combined or can be integrated into another system, or some features can be omitted or skipped. Moreover coupling or direct coupling or communicative connection between the respective components as illustrated or described can be indirect coupling or communicative connection via some interface, device or unit and can be in an electrical, mechanical or another form.

The units described as separate components may or may not be physically separate, and the components illustrated as units may or may not be physical units and can be co-located or can be distributed to a plurality of network elements; and some or all of the units can be selected as needed in practice for the purpose of the solution according to the present embodiment.

Moreover all the respective functional units in the respective embodiments of the application can all be integrated into a processing unit, or the respective units can be arranged separately as single units, or two or more of the foregoing units can be integrated into a single unit; and the foregoing integrated units can be embodied in the form of hardware or can be embodied in the form of hardware plus software functional units.

Those ordinarily skilled in the art can appreciate that all or a part of the step s in the embodiments of the methods can be performed by a piece of program instructing a relevant item of hardware, and the foregoing program can be stored in a computer readable storage medium, and the program upon being executed can perform the steps of the foregoing embodiments of the method; and the foregoing storage medium can include a mobile storage device, a Read-Only Memory (ROM), a Random Access Memory (RAM), a magnetic disk, an optical disk and various mediums capable of storing program codes.

Alternatively the foregoing integrated units of the application can be stored in a computer readable storage medium if they are embodied in the form of software functional modules and sold or used as separate products. With such understanding in mind, the technical solutions according to the embodiments of the application substantially or their contributing parts to the existing technology can be embodied in the form of a software product which is stored in a storage medium and which includes several instructions to cause a computer device (which can be a personal computer, a server, a network device, etc.) to perform all or a part of the methods according to the respective embodiments of the application. The foregoing storage medium can include a mobile storage device, a Read-Only Memory (ROM), a Random Access Memory (RAM), a magnetic disk, an optical disk and various mediums capable of storing program codes.

The foregoing description is merely illustrative of particular embodiments of the application, but the scope of the application will not be limited thereto, and any variations or substitutions that will readily occur to those skilled in the art without departing from the scope of the inventive disclosure shall come into the scope of the application. Accordingly the scope of the application shall be as defined in the appended claims.

1. A control method, applied to an electronic device comprising an image acquisition unit and a light source, wherein an acquisition region of the image acquisition unit at least partially overlaps with an illumination region of the light source, and the method comprises:
obtaining a distance between the image acquisition unit and an acquired object in the acquisition region;
obtaining a set of correspondence relationships of distances between the image acquisition unit and acquired objects with respect to light source parameters, wherein the set includes at least two different correspondence relationships;
selecting a light source parameter according to the obtained distance and the correspondence relationship; and
controlling the light source according to the light source parameter in the course of acquiring the acquired object by the image acquisition unit.

2. The method according to claim 1, wherein the obtaining a distance between the image acquisition unit and an acquired object in the acquisition region comprises:
detecting a motion distance of a driving unit of the electronic device and calculating the distance between the image acquisition unit and the acquired object from the motion distance.

3. The method according to claim 2, wherein the calculating the distance between the image acquisition unit and the acquired object from the motion distance comprises:
obtaining an image distance from a duty ratio of a pulse width modulation signal received by the driving unit; and
calculating an object distance according to a relationship among object distances, focus distances and image distances, wherein the object distance is the distance between the image acquisition unit and the acquired object.

4. The method according to claim 1, further comprising:
determining a distance range into which the obtained distance falls, and selecting a correspondence relationship in the set of correspondence relationships according to a mapping table of distance ranges to correspondence relationships.

5. The method according to claim 1, wherein the controlling the light source comprises controlling power of the light source or controlling the number of activated light sources in a set of light sources.

6. The method according to claim 1, wherein the method further comprises controlling a value of exposure compensation according to the obtained distance by:
obtaining a maximum light compensation distance from a maximum Guild Number of the light source of the image acquisition unit and a current aperture; and
selecting a Guild Number as the light source parameter, in the case that the distance between the image acquisition unit and the acquired object is larger than or equal to the maximum light compensation distance, and
selecting a ratio of the Guild Number multiplied by the distance between the image acquisition unit and the acquired object to the maximum light compensation distance as the light source parameter, in the case that the distance between the image acquisition unit and the acquired object is smaller than the maximum light compensation distance.

7. The method according to claim 1, wherein the method further comprises:
obtaining a brightness value of a preset acquired object; and
judging an activation of the light source, in the case that a ratio of the brightness value of the preset acquired object to a maximum brightness value is smaller than a preset value.

8. The method according to claim 7, wherein the preset acquired object is a human face; and
the obtaining a brightness value of the preset acquired object comprises:
recognize the human face; and
making a statistic of pixels in a central part of the human face to obtain the brightness value.

9. A control apparatus, applied to an electronic device including an image acquisition unit and a light source, wherein an acquisition region of the image acquisition unit at least partially overlaps with an illumination region of the light source, and the apparatus comprises:
a distance obtaining unit configured to obtain a distance between the image acquisition unit and an acquired object in the acquisition region;
a correspondence relationships set obtaining unit configured to obtain a set of correspondence relationships of distances between the image acquisition unit and acquired objects with respect to light source parameters, wherein the set includes at least two different correspondence relationships;
a light source parameter selection unit configured to select a light source parameter according to the obtained distance and the correspondence relationship; and
a light source control unit configured to control the light source according to the light source parameter in the course of acquiring the acquired object by the image acquisition unit.

10. The apparatus according to claim 9, wherein the distance obtaining unit is further configured to detect a motion distance of a driving unit of the electronic device, and to calculate the distance between the image acquisition unit and the acquired object from the motion distance.

11. The apparatus according to claim 10, wherein the distance obtaining unit is further configured to obtain an image distance from a duty ratio of a pulse width modulation signal received by the driving unit; and
to calculate an object distance according to a relationship among object distances, focus distances and image distances, wherein the object distance is the distance between the image acquisition unit and the acquired object.

12. The apparatus according to claim 9, wherein the apparatus further comprises: a correspondence relationship selection unit configured to determine a distance range into which the obtained distance falls, and to select a correspondence relationship from the set of correspondence relationships according to a mapping table of distance ranges to correspondence relationships.

13. The apparatus according to claim 9, wherein the light source control unit is further configured to control power of the light source or to control the number of activated light sources in a set of light sources.

14. The apparatus according to claim 9, wherein the apparatus further comprises:
a maximum light compensation distance determination unit configured to obtain a maximum light compensation distance from a maximum Guild Number of the light source of the electronic device, and a current aperture value;
a light source parameter selection unit configured to select a Guild Number as the light source parameter, in the case that the distance between the image acquisition unit and the acquired object is larger than or equal to the maximum light compensation distance, and to select a ratio of the Guild Number multiplied by the distance between the image acquisition unit and the acquired object to the maximum light compensation distance as the light source parameter, in the case that the distance between the image acquisition unit and the acquired object is smaller than the maximum light compensation distance; and
the light source control unit is configured to control the light source according to the light source parameter in the course of acquiring the acquired object by the image acquisition unit.

15. The apparatus according to claim 9, wherein the apparatus further comprises a brightness value obtaining unit and a judgment unit; and wherein
the brightness value obtaining unit is configured to obtain a brightness value of the preset acquired object; and
the judgment unit is configured to judge an activation of the light source, in the case that a ratio of the brightness value of the preset acquired object to a maximum brightness value is smaller than a preset value.

16. The apparatus according to claim 15, wherein the preset acquired object is a human face; and
the brightness value obtaining unit is configured to recognize the human face, and to make a statistic of pixels in a central part of the human face to obtain the brightness value.

17. An electronic device, comprising a control apparatus applied to an electronic device including an image acquisition unit and a light source, wherein an acquisition region of the image acquisition unit at least partially overlaps with an illumination region of the light source, and the apparatus comprises:
a distance obtaining unit configured to obtain a distance between the image acquisition unit and an acquired object in the acquisition region;
a correspondence relationships set obtaining unit configured to obtain a set of correspondence relationships of distances between the image acquisition unit and acquired objects with respect to light source parameters, wherein the set includes at least two different correspondence relationships;
a light source parameter selection unit configured to select a light source parameter according to the obtained distance and the correspondence relationship; and
a light source control unit configured to control the light source according to the light source parameter in the course of acquiring the acquired object by the image acquisition unit.

18. The electronic device according to claim 17, wherein the distance obtaining unit is further configured to detect a motion distance of a driving unit of the electronic device, and to calculate the distance between the image acquisition unit and the acquired object from the motion distance.

19. The electronic device according to claim 18, wherein the distance obtaining unit is further configured to obtain an image distance from a duty ratio of a pulse width modulation signal received by the driving unit; and
to calculate an object distance according to a relationship among object distances, focus distances and image distances, wherein the object distance is the distance between the image acquisition unit and the acquired object.

20. The electronic device according to claim 17, wherein the apparatus further comprises: a correspondence relationship selection unit configured to determine a distance range into which the obtained distance falls, and to select a correspondence relationship from the set of correspondence relationships according to a mapping table of distance ranges to correspondence relationships.
